(19) United States
(12) Patent Application Publication
(10) Pub. No.: US 2005/0077683 A1
(43) Pub. Date: Apr. 14, 2005

(54) Method for making a composite sealing joint strip

(75) Inventors: Ahmet Comert, Chaineux (BE); Dominique Petit, Blegny (BE); Marc Mertens, Spa (BE)

Correspondence Address: OBLON, SPIVAK, MCCLELLAND, MAIER & NEUSTADT, P.C., 1940 DUKE STREET, ALEXANDRIA, VA, 22314, US

(73) Assignee: Saint Gobain Performance Plastics Chaineux USA, Chaineux (BE)

(21) Appl. No.: 10/494,525

(22) PCT Filed: Oct. 30, 2002
(86) PCT No.: PCT/FR02/03731

(30) Foreign Application Priority Data
Nov. 21, 2001 (FR) 01/15039

(51) Int. Cl. F16J 9/00

(52) U.S. Cl. 277/300

(57) ABSTRACT

According to the invention, the element, especially such as a motor vehicle door module (2), ready to be fastened onto a frame or other surface, is characterized in that the element is provided with a composite sealing bead of defined shape and defined cross section, said composite sealing bead having at least one catching part suitable for cooperating with a surface or frame of said element (2), at least one elastic part (5) and at least one adhesive part (6).

The present invention relates to a method of manufacturing a composite sealing bead suitable for assembling a modular element, especially such as a motor vehicle door module ready to be fastened onto a frame or other surface.

The current tendency, especially in the motor vehicle field, is, right from the design and production of these “modular” elements, especially in the case of vehicle doors, to integrate, into these modular elements, additional functions that are normally fulfilled by the frame or the other surface, with which said element has to cooperate. The term “modular element” is also understood to mean either an internal finishing panel, which is intended to furnish the vehicle's door and is visible from inside the vehicle, or an intermediate sealing sheet placed between said finishing panel and the automobile door.

This has the purpose of making it easier to assemble the vehicle by reducing the number of assembling operations on an assembly line, items of equipment and/or accessories fastened to the modular element having been mounted beforehand in a separate unit or workshop.

Thus, modular elements for a vehicle door are known, which generally are in the form of a furnishing cover and are suitable for cooperating with the internal face of the vehicle's door so as, for example, to mask and protect the door closure mechanisms and/or the mechanisms for moving the side windows within the door.

The modular element is generally fastened to a door element by screwing, or by fit-in means, and it is necessary, at the interface between the modular element and the door element, to interpose a seal so as to protect the volume lying within said door from environmental attack (moisture, dust, vibration, etc.).

For this purpose, it is known to interpose at the interface, as seal, a foamed sealing bead of the type indicated in the document EP 0 930 323.

Although this foamed seal best fulfils its sealing function when the door element and the modular element cooperate with each other perfectly, it sometimes happens that, despite optimum fastening between the two facing elements, the seal is not compressed over its entire perimeter and that a breach is opened, creating a passage for possible environmental attack. This situation generally arises from variations in the dimensional manufacturing tolerances on the door element and/or the modular element, it being possible for these minimum tolerance values to occur at the same time.

For the purpose of achieving the shortest possible assembly time for these modular elements, it would seem to be desirable to preequip them with sealing means online in a short time.

It is an objective of the present invention to provide a novel way of preparing modular elements provided with sealing means, which modular elements can be stored for a certain period, to be able to be mounted directly on a frame or another receiving surface, especially a door element, in a small number of operations. The sealing means must be as effective as possible in order to ensure that there is a seal between the modular element and the receiving surface facing it, whatever the phase in which the sealing means is mechanically stressed (compression, extension, shear).

This objective, together with others that will appear later, has been achieved with a method of producing a sealing bead between a first element and a second element, characterized in that one element chosen from the first and second elements is provided with a composite sealing bead of defined shape and cross section, of a composite sealing bead having at least one catching part, suitable for cooperating with said element chosen from the first and second elements, at least one elastic part and at least one adhesive part suitable for cooperating with the other element when the first and second elements are to be fitted together.

By manufacturing a composite sealing bead having an elastic part interposed between an adhesive part and a catching part, this ensures that there is a perfect seal between the two elements. The adhesive part and the catching part always remaining fastened to their respective element whatever the mode of deformation of the elastic part of said composite sealing bead.

Furthermore, the composite construction of the sealing bead allows it to fulfill itself a certain number of additional functions, such as contribution to the fastening of the two elements together, soundproofing and shock absorption, by adapting a specific portion of the bead.

In preferred embodiments, the invention may optionally have in addition one or more of the following arrangements:
the composite sealing bead is deposited beforehand in a transfer mold before it is applied to either of the first and second elements;
the composite sealing bead is deposited directly on either of the first and second elements;
the composite sealing bead is deposited by at least one extrusion step;
the composite sealing bead is formed by extruding a one-component product;
the composite sealing bead is formed in an extrusion head by reaction between at least two components brought separately into said extrusion head;
the elastic part of the composite sealing bead has, on its peripheral surface, a skin forming an impermeable covering;
the elastic part of the composite sealing bead is a foamed material;
the elastic part is based on a thermoplastic elastomer or on a polyurethane which may or may not be modified by an elastomer;
the elastic part represents at least 50% by volume of the composite sealing bead;
the adhesive part of the composite sealing bead consists of a repositionable thermally activatable, photoactivatable, chemically activatable adhesive;
the adhesive part of the composite sealing bead consists of an adhesive that has a permanent tack or is moisture-reactive, protected by a peelable film;
the adhesive part is formed with the peelable film and is deposited by transfer onto the elastic part of the composite sealing bead during removal of said peelable film;
the adhesive part of the composite sealing bead consists of a hot-melt adhesive or is formed from a liquid adhesive or an adhesive in a liquid vehicle;
the adhesive part of the composite sealing bead consists of a sprayable adhesive;
the adhesive part and the elastic part of the composite sealing bead are formed from an identical product;
the catching part of the composite sealing bead consists of an adhesive part;
the adhesive part is coextruded with the elastic part;
the adhesive part is deposited on one of the first and second elements and the elastic part is deposited on the other of said first and second elements; and
the peelable film consists of a sprayable product.

According to a further aspect, the subject of the invention is also an element, especially such as a motor vehicle door module, ready to be fastened onto a frame or other surface, characterized in that the element is provided with a composite sealing bead of defined shape and defined cross section, said composite sealing bead having at least one catching part suitable for cooperating with a surface or frame of said element, at least one elastic part and at least one adhesive part.

The composite sealing bead may fulfill a damping function with regard to sound, contributing to the soundproofing of the assembly, or with regard to shocks or stresses, by absorbing mechanical shocks or deformations. It may also accommodate the tolerances on the bodywork dimensions.

In one particular embodiment, the composite sealing bead has an elastic or viscoelastic part, which may be manufactured by a process in which a plastic is chemically foamed by means of a chemical agent (whether an additive or a reactive function of the plastic itself that releases a gas which expands the plastic, or by a process in which a plastic is physically foamed by means of a gas mixed with the plastic in order to expand the latter.

Another type of foaming or expansion consists in adding expanded or expandable microspheres, for example of the EXPANCEL brand from Akzo Nobel, or glass microspheres, for example of the ARMOSPHERES brand from A.M.L. International or E-SPHERES from Envirospheres Pty Ltd.

Among materials that can be used to produce the elastic part, mention may be made by way of example of plasticized polyvinyl chloride, thermoplastic elastomers or polyurethanes, which may or may not be modified by an elastomer, polyolefins or rubbers, especially butyl, EPDM (ethylene-propylene-diene), nitrile, styrene-butadiene, etc.

In general, thermoplastic elastomers (TPEs) consist of blends of polymers or of block copolymers manifesting a thermoplastic phase and an elastomeric phase possibly chemically bonded together in the case of a copolymer. An example of this is the product with the brand name SANTOPRENE from AES, which consists of a polypropylene (PP)/EPDM blend, the EPDM being crosslinked in the form of nodules embedded in the continuous PP phase, with a variable PP weight ratio with respect to the EPDM. Also known are products based on block copolymer chains with elastomer blocks, especially isoprene or butadiene blocks, hydrogenated or otherwise, which are linked to thermoplastic blocks, especially polystyrene blocks, for example the products with the brand name KRATON from Shell.

Also known are thermoplastic urethanes (TPUs) available in the form of a nonreactive polymer obtained from several polyol sources, at least one of which forms a block having thermoplastic properties and at least one other forms a block having elastic properties. Examples are the products PEARLTHANE or PEARLCOAT from Merquinsa, or ELASTOLLAN from Elastogran.

It is also possible to form the elastic part of the composite sealing bead based on polyurethane with a great variety of commercially available reactive compositions of the one-component or two-component type. As examples, mention may especially be made of one-component compositions based on a polyurethane prepolymer with a polyester, polyether, polycaprolactone, polyolefin or polysiloxane backbone. A prepolymer with isocyanate end groups cures in the presence of moisture with a certain foaming tendency; a prepolymer having siloxane end groups cures in the presence of moisture without foaming. These polyurethane compositions may be modified by an elastomer, especially a nitrile, SBR or butyl rubber, or a thermoplastic elastomer or a polymer having a certain flexibility but which is not crosslinkable, such as polyolefins or plasticized PVC. Examples of such compositions that can be used for manufacturing foamed or cellular materials, especially by the addition of a foaming gas, are described in EP-A-0 326 704 or EP-A-0 930 323.

The material of the elastic part of the composite sealing bead may furthermore contain organic or mineral fillers, such as talc, silica, calcium carbonate, alumina or metals.

The elastic part of the composite sealing bead has a density of less than 2.5, especially around 0.8 to 2.5 in the case of noncellular materials or 0.03 to 1 in the case of foamed or cellular materials.

The composite sealing bead also includes an adhesive part attached to one of the faces of the elastic part and intended to contribute to the bond between the first and second elements, in particular between a door module and a door of a motor vehicle. This adhesive part is in the form of a layer of adhesive and is chosen to remain inert during the storage period and to be optionally activated at the time of assembly.

In particular embodiments, the layer of adhesive consists of an adhesive which is thermally activatable, photoactivatable, chemically activatable, repositionable, moisture-reactive and/or has a permanent tack. The same adhesive may have several of these properties combined.

When a repositionable adhesive is used, this is formulated so that, when the two elements are separated, a clear discontinuity appears, leaving one of the two elements unstained by any adhesive residue (this is useful when disassembling the door, and allows the module to be reused). In contrast, when this adhesive is not repositionable, it is formulated so that failure occurs within the elastic part, leaving a continuous deposit of adhesive on each of the elements.

The layer of adhesive consists of an adhesive protected by a peelable film. As a variant, a a layer of adhesive is deposited on one of the faces of the peelable film, which layer, by transfer and after removal of said film, is on the elastic part of the seal.

Thermal activation generally requires exposing the adhesive to temperatures exceeding room temperature in any season in temperate climates; in general, it is unnecessary generally to provide a particular protection for neutralizing the adhesive during the storage period. As a variant, it is also possible to use adhesives (especially epoxy-based adhesives) which have to be stored at very low temperature so as to remain inert.

Likewise, an adhesive that can be activated by a defined chemical reactant is generally not sensitive to the ambient atmosphere. An adhesive that can be photoactivated by visible light may advantageously be protected from light by an opaque film. A moisture-reactive adhesive must be protected by a moisture barrier film in order to be able to be stored for a long time. An adhesive having permanent tack must be protected from any contact during its storage. In all cases, a protective film, even if it is not obligatory, is desirable in order to prevent the surface of the adhesive being contaminated with dust which could hamper the final adhesive bonding.

As regards film, a plastic film may be used, especially a polyethylene, polyester, polyvinylchloride or polyvinylidene chloride or polyamide film, which may or may not be coated with a layer of silicone, especially fluorosilicone, in order in particular to protect a silicone-based adhesive layer. The film may also be reinforced by a layer of metal, especially aluminum, or it may consist of a composite.

Examples of thermally activated adhesives comprise resins of the epoxy, polyurethane, especially prepolymers having blocked or unblocked isocyanate end groups, polyether or polyester, especially polyacrylic, oxyalkylene or vinyl, and thermoplastics of polyolefin, especially polyethylene or polypropylene, or polyamide type. The layer of adhesive may consist of a hot-melt adhesive, known hot-melt adhesives including butyl, especially styrene-butadiene rubbers, ethylene/vinyl acetate copolymers (EVA), polyamides, polyaminoamides, or derived copolymers, polyesters and polyurethane-based compositions. The adhesive may contain heat-activated crosslinking catalysts or curing additives.

Reactive or moisture-curing adhesives may be chosen from polyurethane prepolymers having blocked or unblocked isocyanate end groups or silane-terminated end groups, or silicones.

Chemically activatable adhesives may especially be the reactants curing by oxidation, or compositions containing an adhesive and an encapsulated or heat-activatable curing catalyst.

Examples of adhesives having permanent tack consist especially of acrylic polymers, elastomers, whether thermoplastic elastomers or not, polyolefins and polyurethanes, the permanent tack of which is provided or improved by the addition of tackifying resins and oils, or else by polyurethanes formed from one or more diols or diamines and diisocyanates in nonstoichiometric proportions.

As regards the use of the additive for forming said layer of adhesive, it is advantageous to use a hot-melt adhesive capable of being used in the molten state, or a liquid adhesive or an adhesive in a liquid vehicle, especially as an organic solution or as an aqueous suspension/dispersion which forms an adhesive layer by evaporation of the solvent vehicle or diluent.

As a variant, the adhesive may be sprayed and be in the form of a foam.

The adhesive is chosen to be compatible with the material of the elastic part of the composite sealing bead, whether it can be envisaged to treat the internal face of the layer of adhesive and/or the surface of the elastic part of the composite sealing bead with adhesion promoters or primers, or even to interpose another adhesive between the elastic part of the composite sealing bead and the layer of adhesive.

The bonding of the layer of adhesive to the elastic part of the composite sealing bead may be reinforced by the fact that at least one of the surfaces of the elastic part and of the layer of adhesive which are in contact with each other is textured. The relief of the texturing has the effect of increasing the area of contact between these two parts of the sealing bead and therefore of increasing the adhesion.

The composite sealing bead also includes a catching part intended to contribute to the bond between the first and second elements, in particular between the door module and the door of the motor vehicle. This catching part is located on one of the faces of the elastic part of the composite sealing bead, this face being, however, different from that which is coated with the aforementioned layer of adhesive. To take a nonlimiting example, this catching part is positioned symmetrically with respect to the layer of adhesive deposited beforehand on the elastic part.

This catching part may be:
either in the form of one face of the elastic part, this face then being intended to cooperate with a groove or the like produced in one of the first and second elements, one region of the elastic part is trapped within the groove and thus produces a catching part;
or in the form of a layer of adhesive similar to the layer already located on one of the other faces of the elastic part of the composite sealing bead.

Whatever the embodiment of the catching part, this is intended to cooperate with one of the walls of one of the first and second elements.

The bond between the first and second elements is produced in the following manner:

After the sealing bead according to the invention has been produced by a manufacturing process that will be explained in detail later, the adhesive part of the composite sealing bead is made to cooperate with one of the facing faces belonging to the first or second element, the elastic part of the composite sealing bead is mechanically stressed or deformed (for example in compression, in extension or in shear), and the catching part of the composite sealing bead is then brought up and then fastened to another face of the facing assembly belonging to the other element. This fastening of the catching part is accomplished either mechanically or using an adhesive layer.

The method according to the invention allows a composite sealing bead to be shaped so as to reproduce a sealing pattern between two elements, advantageously when this pattern is a closed curve which especially follows at least part of the periphery of the modular element. The method furthermore makes it possible to shape the cross section of the sealing bead so that it fits perfectly into the space that is reserved for it in the final assembling operation, taking into account its deformability.

According to one embodiment, the composite sealing bead is formed on the first element or on the second element.

After having deposited, possibly using an extrusion process, a layer of adhesive on one of the faces of said element and in the desired sealing pattern, a one-component or multicomponent product is then deposited, possibly by an extrusion process similar to the previous one, on the layer of adhesive and in the same sealing pattern, this product having to form the elastic part of the composite sealing bead. In the case of a multicomponent product, the seal may be formed, in an extrusion head, by the reaction between at least two components fed separately into said extrusion head.

When the elastic part of the composite sealing bead has been formed, and when it has reached its desired cross section and its mechanical properties, especially in terms of flexibility, surface finish and hardness, then has a bonding surface. This bonding surface is intended to cooperate with a surface of the other modular element (the first or the second element). The cooperation takes place either by adhesive bonding or by catching.

In the case of an adhesive bonding, the preformed composite sealing bead may be provided with an adhesive surface as bonding surface on that side where the modular element is presented, or else it is the modular element itself which has an adhesive surface—the modular element possibly adhering to the bead because it (or at least part of it) is formed in contact with the composite bead from a substance adhering to the latter.

According to another embodiment, different from the previous embodiments, the composite sealing bead may be formed by depositing the layer of adhesive in a mold cavity and by molding the elastic part of the composite sealing bead in the mold cavity by depositing a suitable moldable product on the layer of adhesive in the mold cavity.

Depending on the way in which the modular element used is obtained, it is then possible:
either to form the composite sealing bead as a single piece with one of the modular elements; the modular element (or at least one portion of the latter) can therefore be molded directly on the layer of adhesive so as simultaneously to produce the modular element (or the modular element portion) and the composite sealing bead;
or to form the bead from the modular element separately; it is possible either to transfer the composite bead to a prefabricated modular element or to mold the modular element in contact with the sealing bead in said cavity. The sealing bead can then be cured in the mold and/or after the composite sealing bead has been transferred to the modular element.

The moldable material may be deposited in a closed mold by injecting a liquid. A process may also be carried out in a mold cavity by extrusion (or another suitable delivery method) of a viscous or pasty material, with the aid of movable delivery means, the mold being stationary, or else stationary delivery means, the mold then being movable.

The molding technique also applies to the production of the adhesive part of the composite sealing bead, reproducing the bonding pattern, this adhesive part of the sealing bead being protected or activatable on one face and having a surface for bonding to the modular element. The adhesive part may be obtained in a mold cavity, possibly containing a protective film, by injection molding or by extrusion of a viscous material in the cavity.

If the adhesive part of the composite sealing bead is protected by a peelable film, the moldable adhesive material is chosen from those in which the modulus of elasticity in the uncrosslinked state is sufficient to allow the film to be peeled off without tearing the elastic part of the sealing bead.

Such materials comprise, in particular, moisture-crosslinkable systems that can be protected by a moisture barrier film, especially systems of the one-component, preferably thermoplastic, polyurethane type, possibly modified by an elastomer. Such a system is a polyurethane prepolymer having a backbone of the polyester, polyether or polyolefin type, obtained for example from a polyol and a polyisocyanate, at least one of which has a polymeric or oligomeric backbone as mentioned above.

As a variant, the composite sealing bead may be formed by depositing the preformed, especially premolded, elastic part of the sealing bead on the layer of adhesive in the mold cavity, the superposition of the two parts in another mold allowing the precise shape of the sealing bead to be controlled. In this variant, the preformed elastic part of the sealing bead may be an integral part of a modular element (or a portion of the latter) manufactured by molding.

In both cases, the layer of adhesive may be deposited in the mold in the form of a preformed strip or of reactive, liquid or viscous material. The adhesive may also be provided with the elastic part of the seal by coextrusion or by spraying.

Preferably, a peelable protective film is applied beforehand to the surface of the mold cavity as mold release agent. This peelable film may constitute the protection for the adhesive part. In particular, the film may have moisture barrier properties in order to protect a layer of moisture-reactive adhesive.

When applying a composite sealing bead which has been produced separately for which the catching part of the latter consists of a layer of adhesive, this adhesive may be placed between the composite sealing bead and the modular element. This adhesive may be identical to or different than that already used to form the adhesive part of the composite sealing bead.

Such a composite sealing bead may be manufactured especially by coextruding the adhesive on at least one of the faces of the elastic part of the composite sealing bead, it being possible for the coextrusion product to be deposited in a mold cavity preequipped with a protective film, in order to assume its final shape. The term “coextrusion” is understood here to mean both the formation of the elastic part and of at least one adhesive part the sealing bead simultaneously with its deposition by means of an extrusion head fed with at least two extrudable materials, and the application of at least one adhesive material in an extrusion head through which the elastic part of the preformed sealing bead, especially one preformed by extrusion, passes.

In another embodiment, the material of the elastic part of the composite sealing bead is itself chosen to be adhesive and to bond to the modular element in the uncured or partially cured state or after activation, especially thermal activation.

One manufacturing process consists in depositing, for example in a mold cavity preequipped with a protective film, a layer of adhesive and then a moldable material forming the elastic part of the composite sealing bead (this elastic part possibly being covered with a layer of adhesive), and then in pressing either of the first and second elements against the elastic part of the sealing bead in order to bond the sealing bead to said modular element. Next, the elastic part of the composite sealing bead may possibly be at least partly cured in this mold thus closed by the modular element, before said modular element to which the composite sealing bead is fastened, including as the case may be its protective film, is removed. The curing of the composite sealing bead may be carried out or completed outside the mold by cooling or by reaction with the moisture of the air.

The method according to the invention allows the mass production of modular elements ready to be assembled, this manufacture possibly being automated. The final assembly of these modular elements is very rapid and meets the need to reduce the assembly time for assemblies such as motor vehicles.

Further details and advantageous features will become apparent below on reading the description of illustrative, but nonlimiting, examples of the invention, with reference to the appended drawings in which:

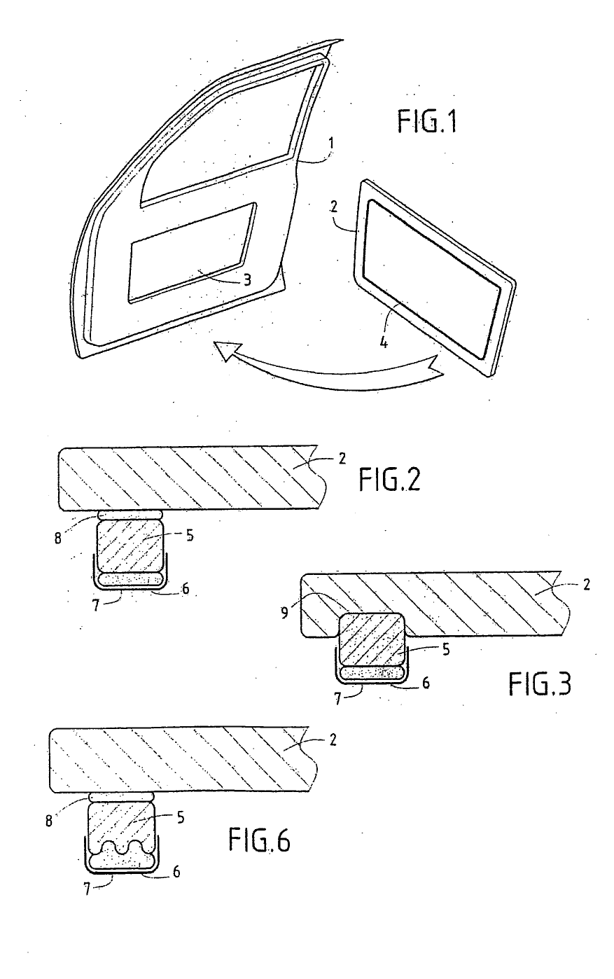

FIG. 1 shows a perspective view of a door module being assembled on an automobile door;

FIG. 2 shows a sectional view of the border region of the door module equipped with a composite sealing bead according to a first embodiment;

FIG. 3 shows a sectional view of the border region of the door module equipped with a composite sealing bead according to a second embodiment;

FIG. 4 illustrates the manufacture of the composite sealing bead by transfer;

FIG. 5 illustrates the manufacture of the composite sealing bead by direct extrusion on one of the elements; and

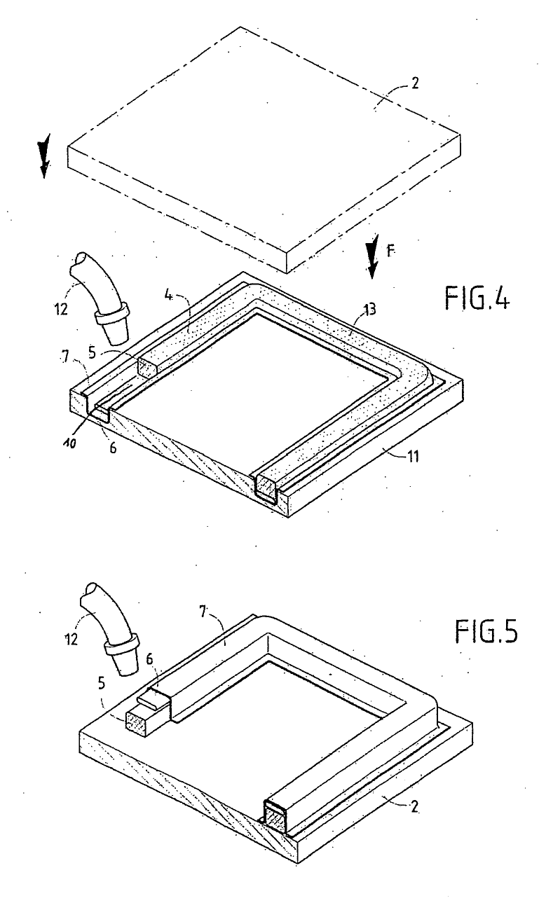

FIG. 6 shows a sectional view of the border region of the door module equipped with a composite sealing bead according to a third embodiment.

It should firstly be pointed out that for the sake of clarity the relative proportions between the various elements shown have not been respected.

FIG. 1 shows a perspective view of a first element, especially a door 1 of a motor vehicle equipped with a second element, especially a door module 2 attached to a surface 3 or frame belonging to said door 1.

The door module 2 is shown in the nonassembled position, in order to reveal its face turned toward the surface 3 of the door 1 of the vehicle. To simplify examination of the figure, no accessory or equipment has been shown on the door module, but it goes without saying that all the usual equipment items, such as a pocket, etc., may be integrated into this module.

The door module 2 is mounted on the surface 3 of the door 1 by interposing, between the internal face of the door module 2 and the surface 3 of the door 1, a composite sealing bead 4. In this case, the sealing pattern is in the form of a closed frame bearing along the periphery of the door module. The sealing bead 4 must ensure that there is a seal between the door module 2 and the door 1 and can also fulfill other functions, such as the absorption of vibrations between the internal space and the external space that are bounded by these two parts, as well as the fastening between the two elements.

The structure of the sealing bead 4 is a composite structure according to the invention and can be seen in FIG. 2, which also shows the structure of the module 2. In this figure, the module is shown as it is before being mounted on the vehicle.

The composite sealing bead 4 is formed from an elastic part 5 bonded to one of the first or second elements and from an adhesive part 6 fastened to the elastic part of the sealing bead and protected by a film 7.

A preferred composition for the flexible part 5 is the following (all the proportions being expressed in % by weight):
polyol: LUPRANOL 2043 sold by BASF: 81.0%;
water: 0.8%;
isocyanate: SUPRASSEC X2647 sold by Huntsman: 17.0%; and
catalyst: TOYOCAT B41 sold by Tosoh: 1.2%.

The bonding between the elastic part 5 of the sealing bead 4 and one of the elements may be achieved by means of a second adhesive part 8 (FIG. 2) or by means of a catching part 9 (FIG. 3).

The sealing bead 4 has a calibrated cross section according to the permitted separation between the first and second elements. In this case, the cross section is shown as being approximately square, but it may be of any other cross section. To fulfill the sealing function, and to compensate for the manufacturing tolerances on the bodywork, the elastic part 5 of the sealing bead 4 is made of a viscoelastic material.

On the opposite side of the door module, the sealing bead 4 is provided with an adhesive layer 6 at least partly covering the surface of the bead.

As small an amount of adhesive as possible is used to ensure effective bonding, whereas the elastic part 5 of the sealing bead 4 occupies at least about 50% of the volume of the sealing bead 4. A preferred adhesive material is an adhesive with permanent tack or else a moisture-curing polyurethane. In general, the purpose of the film 7 is to prevent, during the storage period on the premises of the module manufacturer or of the automobile manufacturer, dust from contaminating the sealing bead and to prevent any contact with a surface other than the final assembly surface which could damage the layer of adhesive 6. The function of the film is also to protect the layer of adhesive from the external conditions, especially moisture, light and oxygen, liable to prematurely activate the adhesive 6.

The manufacture of the composite sealing bead is illustrated in FIG. 4. Placed in the cavity 10 of a mold 11 is a film 7 whose face in contact with the mold (which will be the external face of the film once the bead 4 has been completed) may be made of polyethylene in order to act as a release agent for the molded material. According to a variant, not shown in the figures, the film is deposited by spraying. Deposited on the internal face of the film 7 is a layer of adhesive 6 in the form of a strip that can be unreeled or else in the form of a fluid or viscous material, especially a hot-melt adhesive in the molten state or a liquid adhesive or an adhesive in the form of an organic solution or aqueous dispersion, the solvent or diluent of which is evaporated, which layer of adhesive is shaped in the cavity. Next, the material of the elastic part 5 of the sealing bead is deposited on the layer of adhesive 6, for example by means of an extrusion nozzle 12 which is moved along the entire length of the cavity 10 in a closed circuit (it is also possible for the extrusion nozzle 12 to remain stationary and for the mold to move relative to the nozzle). In this way, it is possible to form a bead in the shape of a frame without any discontinuity and therefore resulting in no loss of sealing. The nozzle 12 may have a calibrated cross section in order to give a preliminary shape to the material of the elastic part 5 of the bead 4, which ends up being shaped in the cavity 10 of the mold 11.

As soon as the material of the elastic part 5 of the sealing bead 4 has been deposited, the composite sealing bead may be fitted onto the door module, by transferring it onto the latter: the door module 2, depicted by the dot-dashed line, is pressed (in the direction of the arrows F) against the surface 13 of the not yet cured bead 4 and the material adheres spontaneously to the surface of the module. As a variant, an additional layer of adhesive, which may or may not be identical to that of the layer 6, may be applied to the surface 13 of the elastic part 5 of the cured or uncured sealing bead 4 (if the material of the bead 4 does not adhere spontaneously to the material of the module 2). It is this second layer that then forms the adhesive surface 13 of the bead 4.

After an application time varying in length depending on the materials employed, the door module 2 can be removed from the surface of the mold with the composite bead 4 bonded to its surface. The film 7 is also extracted from the mold cavity and remains attached to the layer of adhesive 6 that it immediately protects from dust and/or moisture.

The module 2 thus equipped with the bonding bead 4 may be held for a time long enough for the bead 4 to cure or for it to acquire the structural properties, and then stored awaiting its use for mounting on a vehicle.

Mounting takes place simply by removing the protective film 7, after which the bead 4 is pressed into contact with the door of the motor vehicle. With a thermally activatable adhesive, the layer of adhesive may firstly be heated, especially by an infrared source, or else the module 2 may be put into place against the door, followed by heating to raise the bonding bead to the temperature needed to activated the adhesive, for example by heating the door.

FIG. 6 shows an alternative embodiment of the composite sealing bead 4, in which the surface of the layer of adhesive 6 which bonds to the elastic part 5 of the sealing bead is textured so as to increase the area of contact between these two parts of the composite sealing bead. Such a layer of adhesive 6 may especially be produced by depositing an adhesive material in the cavity 10 using a nozzle 12 of appropriate cross section. The elastic part 5 of the composite sealing bead 4 is then preferably obtained by extruding a viscous or pasty material onto the textured surface of the layer of adhesive 6. The extruded material of the elastic part 5 of the sealing bead 4 follows the contour of the textured face of the layer 6 over a contact area greater than that with a flat contact, hence resulting in better adhesion.

FIG. 5 illustrates another aspect of the invention in which the composite sealing bead 4 is formed directly on the first element or the second element.

After having deposited, possibly using an extrusion process, a layer of adhesive 8 on one of the faces of said element and in the desired sealing pattern, a one-component or multicomponent product is then deposited, possibly by an extrusion process similar to the previous one, on the layer of adhesive 8 or simply on the catching part 9, and in the same sealing pattern, this product having to form the elastic part 5 of the composite sealing bead 4. In the case of a multicomponent product, the seal 4 may be formed, in an extrusion head, by the reaction between at least two components fed separately into said extrusion head.

The door module 2 has a structure identical to that of the module in FIGS. 2, 3 and 6. It is provided with an elastic part 5 placed around the periphery of the module on or beside the lining.

The elastic part 5 is bonded on a first face to the module 2 and is protected on the other face by a film 7, the protected face being adhesive after the film has been removed.

For this purpose, the elastic part 5 of the bead 4 may be covered with a moisture-crosslinkable adhesive, the film 7 having a moisture barrier function, for example made of low-density polyethylene. The adhesive material that can be used may be chosen from among systems based on polyurethane, advantageously thermoplastic polyurethane, optionally modified by at a polymer, especially an elastomer, in order to give the adhesive the desired mechanical properties. Most particularly preferred among these materials are polyurethane prepolymers having a polymeric or oligomeric, especially polyether and/or polyester, backbone. A moisture-crosslinkable thermoplastic polyurethane composition suitable for this use may be obtained by the hot reaction of 2 parts of a polyester diol sold under the brand name DYNACOLL® 7231 by Degussa-Huls with 1 part of a polyether-based isocyanate prepolymer sold under the brand name LUPRANAT® MP130 by BASF.

The elastic part 5 of the sealing bead 4 is manufactured in a manner very similar to that described above with reference to FIG. 4, except as regards the deposition phase which is carried out directly on the surface of one of the first or second elements, without passing via a transfer mold.

Moreover, the bead may be applied to the second element (or to the first element) by pressing the first element (or the second element) by pressing on the first element (or the second element), the sealing bead still having an adhesive upper face for bonding to said (first or second) element, the material of the core of the sealing bead possibly being cured or set by keeping the first and second elements clamped against each other.

In another alternative embodiment, the adhesive may be chosen from thermally activatable materials, especially hot-melt adhesives, or chemically activatable materials. It is no longer essential in this case to provide the protective film 7, although this is still preferred in order to protect the activatable surface from any dust or dirt liable to counteract the activation and/or adhesion of the activated face.

The invention has been described in the particular case of the manufacture of a door module ready to be mounted on a door frame of a motor vehicle, but it applies to the production of any other modular element, especially window modules that can be used in the automobile industry or in the construction of buildings (conservatories, porches, etc.).

1-21. (canceled)

22. A method of producing a composite sealing bead between a first element and a second element, comprising:
providing one element chosen from the first and second elements with a composite sealing bead of defined shape and defined cross section, the composite sealing bead having at least one catching part, configured to cooperate with the element chosen from the first and second elements, having at least one elastic part, presenting on its peripheral surface, a skin forming an impermeable covering, and having at least one adhesive part configured to cooperate with the other non-chosen of the first and second elements when the first and second elements are to be fitted together.

23. The method as claimed in claim 22, wherein the composite sealing bead is deposited beforehand in a transfer mold before the sealing bead is applied to either of the first and second elements.

24. The method as claimed in claim 22, wherein the composite sealing bead is deposited directly on either of the first and second elements.

25. The method as claimed in claim 22, wherein the composite sealing bead is deposited by at least one extrusion operation.

26. The method as claimed in claim 22, wherein the composite sealing bead is formed by extruding a one-component product.

27. The method as claimed in claim 22, wherein the composite sealing bead is formed in an extrusion head by reaction between at least two components brought separately into the extrusion head.

28. The method as claimed in claim 22, wherein the elastic part of the composite sealing bead comprises a foamed material.

29. The method as claimed in claim 22, wherein the elastic part is based on a thermoplastic elastomer or on a polyurethane that may or may not be modified by an elastomer.

30. The method as claimed in claim 22, wherein the elastic part represents at least 50% by volume of the composite sealing bead.

31. The method as claimed in claim 22, wherein the adhesive part of the composite sealing bead includes a repositionable thermally activatable, photoactivatable, chemically activatable adhesive.

32. The method as claimed in claim 22, wherein the adhesive part of the composite sealing bead includes an adhesive that has a permanent tack or is moisture-reactive, protected by a peelable film.

33. The method as claimed in claim 32, wherein the adhesive part is formed with the peelable film and is deposited by transfer onto the elastic part of the composite sealing bead during removal of the peelable film.

34. The method as claimed in claim 22, wherein the adhesive part of the composite sealing bead includes a hot-melt adhesive or is formed from a liquid adhesive or an adhesive in a liquid vehicle.

35. The method as claimed in claim 22, wherein the adhesive part of the composite sealing bead includes a sprayable adhesive.

36. The method as claimed in claim 22, wherein the adhesive part and the elastic part of the composite sealing bead are formed from an identical product.

37. The method as claimed in claim 22, wherein the catching part of the composite sealing bead includes another adhesive part.

38. The method as claimed in claim 22, wherein the adhesive part is coextruded with the elastic part.

39. The process as claimed in claim 22, wherein the adhesive part is deposited on one of the first and second elements and the elastic part is deposited on the other of the first and second elements.

40. The method as claimed in claim 32, wherein the peelable film includes a sprayable product.

41. An element, ready to be fastened onto a frame or other surface, wherein the element is provided with a composite sealing bead of defined shape and defined cross section, the composite sealing bead having at least one catching part configured to cooperate with a surface or frame of the element, at least one elastic part, and at least one adhesive part.
